(19) United States
(12) Patent Application Publication
(10) Pub. No.: US 2019/0092101 A1
(43) Pub. Date: Mar. 28, 2019

(54) TREAD FOR A TIRE

(71) Applicant: The Goodyear Tire & Rubber Company, Akron, OH (US)

(72) Inventors: Julien Alexandre VAISSAUD, Arlon (BE); Peter André KINDT, Arlon (BE); Alexander OSSIPOV, Leuven (BE)

(21) Appl. No.: 15/712,174

(22) Filed: Sep. 22, 2017

(51) Int. Cl. B60C 11/13

(52) U.S. Cl. CPC B60C 11/13; B60C 2011/0355

(57) ABSTRACT

A tread for a tire includes a first circumferential groove extending in a circumferential direction entirely encircling the tire, the first circumferential groove having two sidewalls extending radially outward from an annular base, each sidewall defining a plane perpendicular to a rotational axis of the tire, and a first groove rib projecting radially outward from the annular base of the first circumferential groove, the first groove rib extending circumferentially and entirely encircling the tire, the first groove rib having two sidewalls extending radially outward from the annular base of the first circumferential groove to a radially outermost annular surface of the first groove rib, each sidewall of the first groove rib defining a plane perpendicular to a rotational axis of the tire, the sidewalls of the first circumferential groove extending circumferentially and parallel to the sidewalls of the first groove rib, the first groove rib having a radial height less than a radial height of the first circumferential groove.

### FIELD OF INVENTION

The present invention relates to a pneumatic tire with an improved tread, and more particularly, relates to a pneumatic tire tread having improved acoustic characteristics.

### BACKGROUND OF THE INVENTION

Conventionally, in addition to circumferential main grooves and lateral grooves, pneumatic tire treads may have sipes on a tread surface in order to demonstrate favorable functional characteristics (e.g., low rolling resistance, good traction, good durability, etc.).

### DEFINITIONS

The following definitions are controlling for the disclosed invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” means circular lines or directions extending along the perimeter of the surface of the annular tread perpendicular to the axial direction; it can also refer to the direction of the sets of adjacent circular curves whose radii define the axial curvature of the tread, as viewed in cross section.

“dBA” means A-weighted decibels, abbreviated dBA, or dBa, or dB(a), which are an expression of the relative loudness of sounds in air as perceived by the human ear. In the A-weighted system, the decibel of sounds at low frequencies are reduced, compared with unweighted decibels, in which no correction is made for audio frequency. This correction is made because the human ear is less sensitive at low audio frequencies, especially below 1000 hertz, than at high audio frequencies.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Hertz” means number of cycles per second.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2% to 0.8% of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### SUMMARY OF THE INVENTION

A tread for a tire in accordance with the present invention includes a first circumferential groove extending in a circumferential direction entirely encircling the tire, the first circumferential groove having two sidewalls extending radially outward from an annular base, each sidewall defining a plane perpendicular to a rotational axis of the tire, and a first groove rib projecting radially outward from the annular base of the first circumferential groove, the first groove rib extending circumferentially and entirely encircling the tire, the first groove rib having two sidewalls extending radially outward from the annular base of the first circumferential groove to a radially outermost annular surface of the first groove rib, each sidewall of the first groove rib defining a plane perpendicular to a rotational axis of the tire, the sidewalls of the first circumferential groove extending circumferentially and parallel to the sidewalls of the first groove rib, the first groove rib having a radial height less than a radial height of the first circumferential groove.

According to another aspect of the tread, the radial height of the first groove rib is one-half the radial height of the first circumferential groove.

According to still another aspect of the tread, a second circumferential groove extends in a circumferential direction entirely encircling the tire, the second circumferential groove having two sidewalls extending radially outward from an annular base, each sidewall defining a plane perpendicular to a rotational axis of the tire; and a second groove rib projects radially outward from the annular base of the second circumferential groove, the second groove rib extending circumferentially and entirely encircling the tire, the second groove rib having two sidewalls extending radially outward from the annular base of the second circumferential groove to a radially outermost annular surface of the second groove rib, each sidewall of the second groove rib defining a plane perpendicular to a rotational axis of the tire, the sidewalls of the second circumferential groove extending circumferentially and parallel to the sidewalls of the second groove rib, the second groove rib having a radial height less than a radial height of the second circumferential groove.

According to yet another aspect of the tread, a third circumferential groove extends in a circumferential direction entirely encircling the tire, the third circumferential groove having two sidewalls extending radially outward from an annular base, each sidewall defining a plane perpendicular to a rotational axis of the tire; and a third groove rib projects radially outward from the annular base of the third circumferential groove, the third groove rib extending circumferentially and entirely encircling the tire, the third groove rib having two sidewalls extending radially outward from the annular base of the third circumferential groove to a radially outermost annular surface of the third groove rib, each sidewall of the third groove rib defining a plane perpendicular to a rotational axis of the tire, the sidewalls of the third circumferential groove extending circumferentially and parallel to the sidewalls of the third groove rib, the third groove rib having a radial height less than a radial height of the third circumferential groove.

According to still another aspect of the tread, a fourth circumferential groove extends in a circumferential direction entirely encircling the tire, the fourth circumferential groove having two sidewalls extending radially outward from an annular base, each sidewall defining a plane perpendicular to a rotational axis of the tire; and a fourth groove rib projects radially outward from the annular base of the fourth circumferential groove, the fourth groove rib extending circumferentially and entirely encircling the tire, the fourth groove rib having two sidewalls extending radially outward from the annular base of the fourth circumferential groove to a radially outermost annular surface of the fourth groove rib, each sidewall of the fourth groove rib defining a plane perpendicular to a rotational axis of the tire, the sidewalls of the fourth circumferential groove extending circumferentially and parallel to the sidewalls of the fourth groove rib, the fourth groove rib having a radial height less than a radial height of the fourth circumferential groove.

According to yet another aspect of the tread, the sidewalls of each of the first, second, third, and fourth groove ribs are parallel to each other.

According to still another aspect of the tread, the sidewalls of each of the first, second, third, and fourth circumferential grooves are parallel to the sidewalls of the first groove rib.

According to yet another aspect of the tread, each of the sidewalls of the first circumferential groove is parallel to each of the sidewalls of the second groove rib.

According to still another aspect of the tread, each of the sidewalls of the second circumferential groove is parallel to each of the sidewalls of the third groove rib.

According to yet another aspect of the tread, each of the sidewalls of the third circumferential groove is parallel to each of the sidewalls of the fourth groove rib.

A method in accordance with the present invention reduces exterior noise of a tread under operating conditions. The method includes the steps of: projecting a first groove rib radially outward from an annular base of a first circumferential groove; extending the first groove rib circumferentially to entirely encircle the tread; extending two sidewalls of the first groove rib radially outward from the annular base of the first circumferential groove to a radially outermost annular surface of the first groove rib; and extending the sidewalls of the first circumferential groove circumferentially and parallel to the sidewalls of the first groove rib, the first groove rib having a radial height less than a radial height of the first circumferential groove.

According to another aspect of the method, the radial height of the first groove rib is one-half the radial height of the first circumferential groove.

According to still another aspect of the method, the method further includes the steps of: projecting a second groove rib radially outward from an annular base of a second circumferential groove; extending the second groove rib circumferentially to entirely encircle the tread; extending two sidewalls of the second groove rib radially outward from the annular base of the second circumferential groove to a radially outermost annular surface of the second groove rib; and extending the sidewalls of the second circumferential groove circumferentially and parallel to the sidewalls of the second groove rib.

According to yet another aspect of the method, the sidewalls of the first groove rib are parallel to the sidewalls of the second groove rib.

According to still another aspect of the method, the sidewalls of the first circumferential groove are parallel to the sidewalls of the second groove rib.

According to yet another aspect of the method, the sidewalls of the second circumferential groove are parallel to the sidewalls of the first groove rib.

According to still another aspect of the method, the sidewalls of the first groove rib are parallel to the sidewalls of the second groove rib.

According to yet another aspect of the method, the annular base of the first circumferential groove forms a cylinder concentric with a cylinder formed by the radially outermost annular surface of the first groove rib.

According to still another aspect of the method, the annular base of the first circumferential groove forms a cylinder concentric with a cylinder formed by the radially outermost annular surface of the second groove rib.

According to yet another aspect of the method, the annular base of the second circumferential groove forms a cylinder concentric with a cylinder formed by the radially outermost annular surface of the first groove rib.

### BRIEF DESCRIPTION OF THE DRAWINGS

The present invention will be more clearly understood by the following description of some examples thereof, with reference to the accompanying drawings, in which:

FIG. 1 is a schematic orthogonal front view of a pneumatic tire having a tread in accordance with the present invention.

FIG. 2 is a schematic sectional view taken along line 2-2 in FIG. 1.

FIG. 3 is a schematic graph demonstrating decreasing noise with the ribs in accordance with the present invention.

FIG. 4 is another schematic graph demonstrating decreasing noise with the ribs in accordance with the present invention.

### DESCRIPTION OF EXAMPLES OF THE PRESENT INVENTION

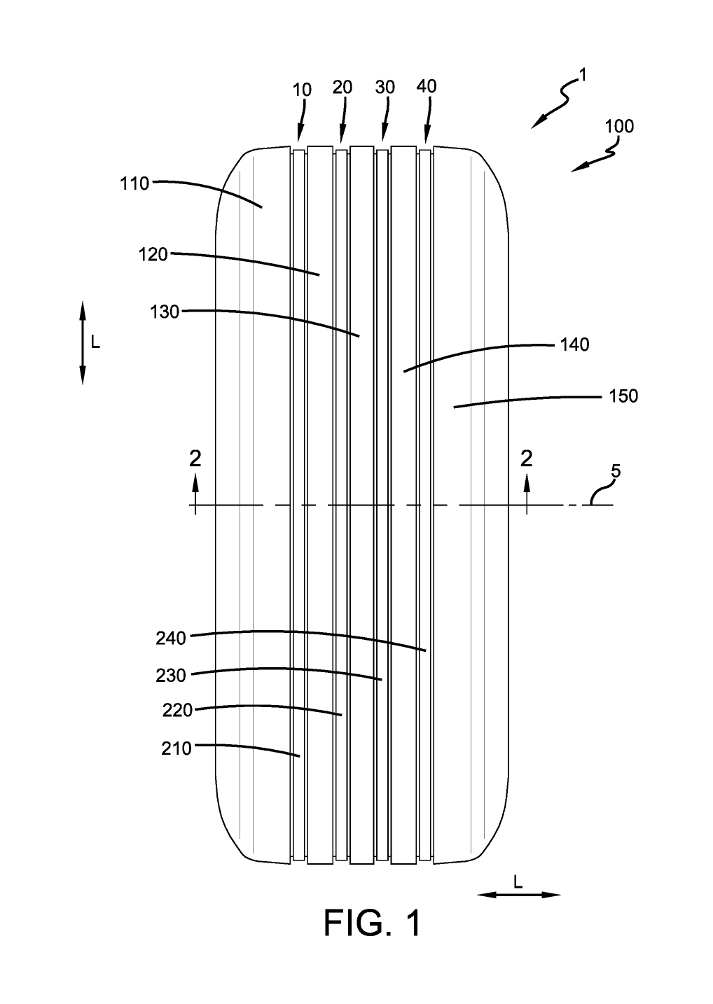

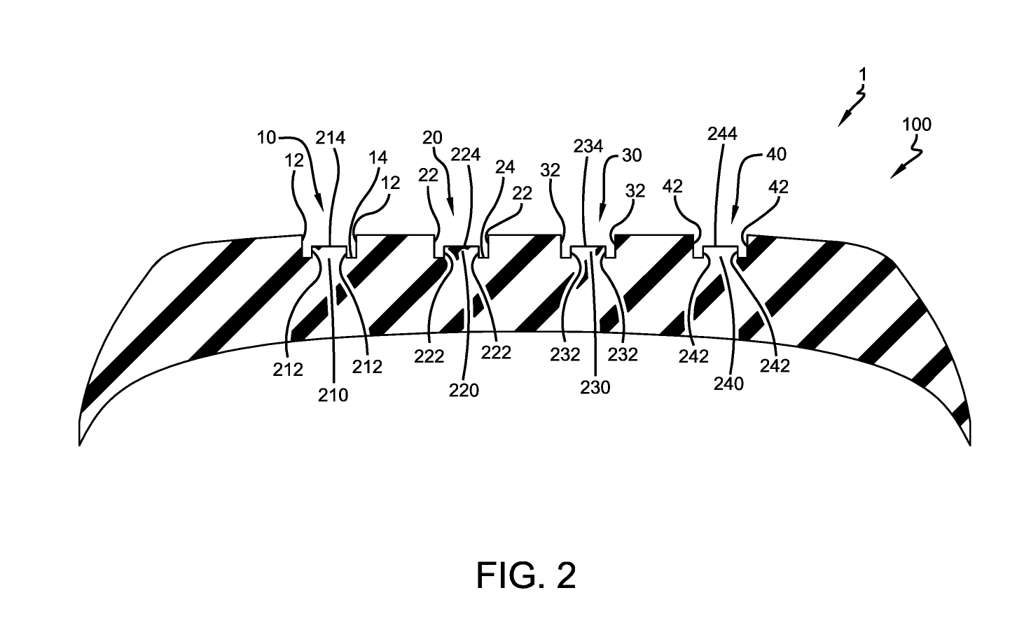

As shown in FIGS. 1-3, a pneumatic tire 1 in accordance with the present invention may include a tread 100 with a first main circumferential groove 10, a second main circumferential groove 20, a third main circumferential groove 30, and a fourth main circumferential groove 40 all extending in a circumferential direction C of the pneumatic tire forming the tread 100. Five land portions, or ribs 110, 120, 130, 140, 150 may be formed by these main circumferential grooves 10, 20, 30, 40. The main circumferential grooves 10, 20, 30, 40 may have, for example, a lateral width between 3.0 mm and 20.0 mm and an example radial depth between 5.0 mm and 13.0 mm.

In accordance with the present invention, the first circumferential groove 10 may have two sidewalls 12 extending radially outward from an annular base 14. Each sidewall 12 may thereby define a plane perpendicular to a rotational axis 5 of the tire 1. Projecting radially outward from the base 14 of the groove 10 may be a rectangular groove rib 210. The groove rib 210 may have two sidewalls 212 extending radially outward from the base 14 to a radially outermost annular surface 214 of the groove rib. Each sidewall 212 may thereby define a plane perpendicular to a rotational axis 5 of the tire 1. The sidewalls 12 of the first circumferential groove 10 may extend circumferentially and parallel to the sidewalls 212 of the groove rib 210. The sidewalls 212 of the groove rib 210 may have a radial height above the base 14 of about one-half a radial height of the sidewalls 12 of the first circumferential groove 10. Alternatively, the sidewalls 212 of the groove rib 210 may have a maximum radial height between 2.5 mm and 4.0 mm, such as 1.6 mm. The radially outermost annular surface 214 of the first groove rib 210 may form a cylinder concentric with a cylinder formed by the annular base 14 of the first circumferential groove 10.

In accordance with the present invention, the second circumferential groove 20 may have two sidewalls 22 extending radially outward from an annular base 24. Each sidewall 22 may thereby define a plane perpendicular to a rotational axis 5 of the tire 1. Projecting radially outward from the base 24 of the groove 20 may be a rectangular groove rib 220. The groove rib 220 may have two sidewalls 222 extending radially outward from the base 24 to a radially outermost annular surface 224 of the groove rib. Each sidewall 222 may thereby define a plane perpendicular to a rotational axis 5 of the tire 1. The sidewalls 22 of the second circumferential groove 20 may extend circumferentially and parallel to the sidewalls 212, 222 of the groove ribs 210, 220. The sidewalls 222 of the groove rib 220 may have a radial height above the base 24 of about one-half a radial height of the sidewalls 22 of the second circumferential groove 20. Alternatively, the sidewalls 222 of the groove rib 220 may have a maximum radial height between 2.5 mm and 4.0 mm, such as 1.6 mm. The radially outermost annular surface 224 of the second groove rib 220 may form a cylinder concentric with the cylinders formed by the annular bases 14, 24 of the first and second circumferential groove 10, 20.

In accordance with the present invention, the third circumferential groove 30 may have two sidewalls 32 extending radially outward from an annular base 34. Each sidewall 32 may thereby define a plane perpendicular to a rotational axis 5 of the tire 1. Projecting radially outward from the base 34 of the groove 30 may be a rectangular groove rib 230. The groove rib 230 may have two sidewalls 232 extending radially outward from the base 34 to a radially outermost annular surface 234 of the groove rib. Each sidewall 232 may thereby define a plane perpendicular to a rotational axis 5 of the tire 1. The sidewalls 32 of the third circumferential groove 30 may extend circumferentially and parallel to the sidewalls 212, 222, 232 of the groove ribs 210, 220, 230. The sidewalls 232 of the groove rib 230 may have a radial height above the base 34 of about one-half a radial height of the sidewalls 32 of the third circumferential groove 30. Alternatively, the sidewalls 232 of the groove rib 230 may have a maximum radial height between 2.5 mm and 4.0 mm, such as 1.6 mm. The radially outermost annular surface 234 of the third groove rib 230 may form a cylinder concentric with the cylinders formed by the annular bases 14, 24, 34 of the first, second, and third circumferential grooves 10, 20, 30.

In accordance with the present invention, the fourth circumferential groove 40 may have two sidewalls 42 extending radially outward from an annular base 44. Each sidewall 42 may thereby define a plane perpendicular to a rotational axis 5 of the tire 1. Projecting radially outward from the base 44 of the groove 40 may be a rectangular groove rib 240. The groove rib 240 may have two sidewalls 242 extending radially outward from the base 44 to a radially outermost annular surface 244 of the groove rib. Each sidewall 242 may thereby define a plane perpendicular to a rotational axis 5 of the tire 1. The sidewalls 42 of the fourth circumferential groove 40 may extend circumferentially and parallel to the sidewalls 212, 222, 232, 242 of the groove ribs 210, 220, 230, 240. The sidewalls 242 of the groove rib 240 may have a radial height above the base 44 of about one-half a radial height of the sidewalls 42 of the fourth circumferential groove 40. Alternatively, the sidewalls 242 of the groove rib 240 may have a maximum radial height between 2.5 mm and 4.0 mm, such as 1.6 mm. The radially outermost annular surface 244 of the fourth groove rib 240 may form a cylinder concentric with the cylinders formed by the annular bases 14, 24, 34, 44 of the first, second, third, and fourth circumferential grooves 10, 20, 30, 40.

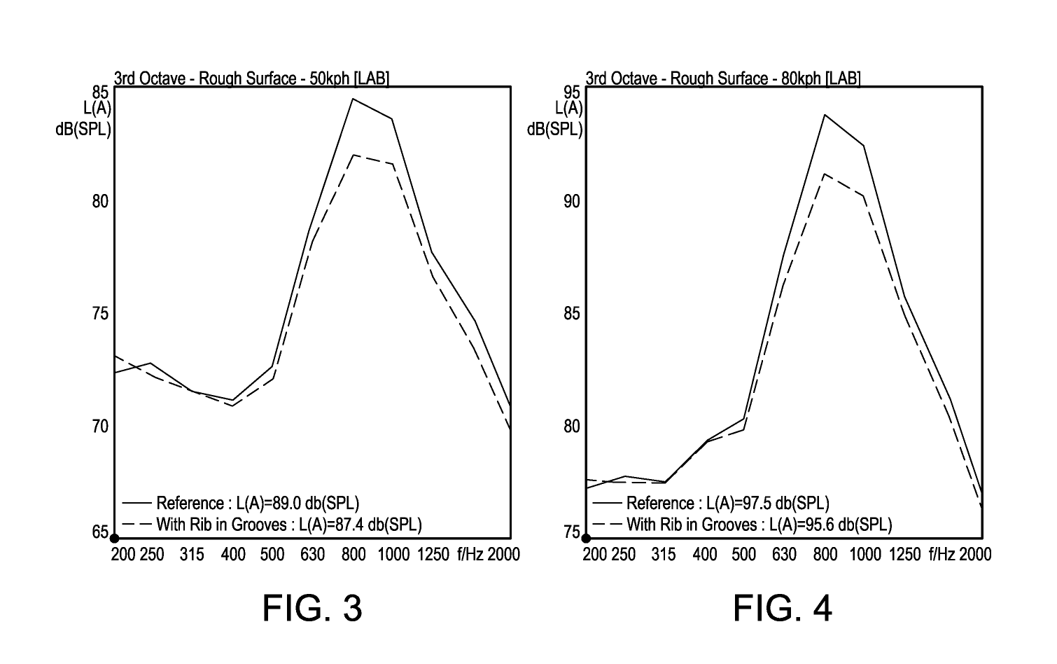

The groove ribs 210, 220, 230, 240 may be disconnected from the sidewalls 12, 22, 32, 42 of the circumferential grooves 10, 20, 30, 40 such that the groove ribs 210, 220, 230, 240 reduce exterior noise under operating conditions of the tread 100 and tire 1 while having minimal effect on other functional characteristics of the tread and tire, such as cornering, braking, rolling resistance, wear, etc. Advantageously, the groove ribs 210, 220, 230, 240 in the circumferential grooves 10, 20, 30, 40 may not significantly alter the structural behavior of the tread 100 and tire 1, other than reduction of noise. FIGS. 3 & 4 show this noise reduction through almost the entire test frequency range when adding the groove ribs 210, 220, 230, 240 to a tread pattern, such as the tread 100.

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements.

What is claimed:

1. A tread for a tire comprising:
a first circumferential groove extending in a circumferential direction entirely encircling the tire, the first circumferential groove having two sidewalls extending radially outward from an annular base, each sidewall defining a plane perpendicular to a rotational axis of the tire; and
a first groove rib projecting radially outward from the annular base of the first circumferential groove, the first groove rib extending circumferentially and entirely encircling the tire, the first groove rib having two sidewalls extending radially outward from the annular base of the first circumferential groove to a radially outermost annular surface of the first groove rib, each sidewall of the first groove rib defining a plane perpendicular to a rotational axis of the tire, the sidewalls of the first circumferential groove extending circumferentially and parallel to the sidewalls of the first groove rib, the first groove rib having a radial height less than a radial height of the first circumferential groove.

2. The tread as set forth in claim 1 wherein the radial height of the first groove rib is one-half the radial height of the first circumferential groove.

3. The tread as set forth in claim 1 further comprising:
a second circumferential groove extending in a circumferential direction entirely encircling the tire, the second circumferential groove having two sidewalls extending radially outward from an annular base, each sidewall defining a plane perpendicular to a rotational axis of the tire; and
a second groove rib projecting radially outward from the annular base of the second circumferential groove, the second groove rib extending circumferentially and entirely encircling the tire, the second groove rib having two sidewalls extending radially outward from the annular base of the second circumferential groove to a radially outermost annular surface of the second groove rib, each sidewall of the second groove rib defining a plane perpendicular to a rotational axis of the tire, the sidewalls of the second circumferential groove extending circumferentially and parallel to the sidewalls of the second groove rib, the second groove rib having a radial height less than a radial height of the second circumferential groove.

4. The tread as set forth in claim 3 further comprising:
a third circumferential groove extending in a circumferential direction entirely encircling the tire, the third circumferential groove having two sidewalls extending radially outward from an annular base, each sidewall defining a plane perpendicular to a rotational axis of the tire; and
a third groove rib projecting radially outward from the annular base of the third circumferential groove, the third groove rib extending circumferentially and entirely encircling the tire, the third groove rib having two sidewalls extending radially outward from the annular base of the third circumferential groove to a radially outermost annular surface of the third groove rib, each sidewall of the third groove rib defining a plane perpendicular to a rotational axis of the tire, the sidewalls of the third circumferential groove extending circumferentially and parallel to the sidewalls of the third groove rib, the third groove rib having a radial height less than a radial height of the third circumferential groove.

5. The tread as set forth in claim 4 further comprising:
a fourth circumferential groove extending in a circumferential direction entirely encircling the tire, the fourth circumferential groove having two sidewalls extending radially outward from an annular base, each sidewall defining a plane perpendicular to a rotational axis of the tire; and
a fourth groove rib projecting radially outward from the annular base of the fourth circumferential groove, the fourth groove rib extending circumferentially and entirely encircling the tire, the fourth groove rib having two sidewalls extending radially outward from the annular base of the fourth circumferential groove to a radially outermost annular surface of the fourth groove rib, each sidewall of the fourth groove rib defining a plane perpendicular to a rotational axis of the tire, the sidewalls of the fourth circumferential groove extending circumferentially and parallel to the sidewalls of the fourth groove rib, the fourth groove rib having a radial height less than a radial height of the fourth circumferential groove.

6. The tread as set forth in claim 5 wherein the sidewalls of each of the first, second, third, and fourth groove ribs are parallel to each other.

7. The tread as set forth in claim 5 wherein the sidewalls of each of the first, second, third, and fourth circumferential grooves are parallel to the sidewalls of the first groove rib.

8. The tread as set forth in claim 5 wherein each of the sidewalls of the first circumferential groove is parallel to each of the sidewalls of the second groove rib.

9. The tread as set forth in claim 5 wherein each of the sidewalls of the second circumferential groove is parallel to each of the sidewalls of the third groove rib.

10. The tread as set forth in claim 5 wherein each of the sidewalls of the third circumferential groove is parallel to each of the sidewalls of the fourth groove rib.

11. A method for reducing exterior noise of a tread under operating conditions, the method comprising the steps of:
projecting a first groove rib radially outward from an annular base of a first circumferential groove;
extending the first groove rib circumferentially to entirely encircle the tread;
extending two sidewalls of the first groove rib radially outward from the annular base of the first circumferential groove to a radially outermost annular surface of the first groove rib; and
extending the sidewalls of the first circumferential groove circumferentially and parallel to the sidewalls of the first groove rib, the first groove rib having a radial height less than a radial height of the first circumferential groove.

12. The method as set forth in claim 11 wherein the radial height of the first groove rib is one-half the radial height of the first circumferential groove.

13. The method as set forth in claim 11 further comprising the steps of:
projecting a second groove rib radially outward from an annular base of a second circumferential groove;
extending the second groove rib circumferentially to entirely encircle the tread;
extending two sidewalls of the second groove rib radially outward from the annular base of the second circumferential groove to a radially outermost annular surface of the second groove rib; and
extending the sidewalls of the second circumferential groove circumferentially and parallel to the sidewalls of the second groove rib.

14. The method as set forth in claim 13 wherein the sidewalls of the first groove rib are parallel to the sidewalls of the second groove rib.

15. The method as set forth in claim 13 wherein the sidewalls of the first circumferential groove are parallel to the sidewalls of the second groove rib.

16. The method as set forth in claim 13 wherein the sidewalls of the second circumferential groove are parallel to the sidewalls of the first groove rib.

17. The method as set forth in claim 13 wherein the sidewalls of the first groove rib are parallel to the sidewalls of the second groove rib.

18. The method as set forth in claim 11 wherein the annular base of the first circumferential groove forms a cylinder concentric with a cylinder formed by the radially outermost annular surface of the first groove rib.

19. The method as set forth in claim 13 wherein the annular base of the first circumferential groove forms a cylinder concentric with a cylinder formed by the radially outermost annular surface of the second groove rib.

20. The method as set forth in claim 13 wherein the annular base of the second circumferential groove forms a cylinder concentric with a cylinder formed by the radially outermost annular surface of the first groove rib.
